(19) United States
(12) Patent Application Publication
(10) Pub. No.: US 2012/0188202 A1
(43) Pub. Date: Jul. 26, 2012

(54) LIQUID-CRYSTAL PANEL EQUIPPED WITH TOUCH SENSOR FUNCTION

(75) Inventors: Kazuya Tsujino, Osaka-shi (JP); Keiichi Yamamoto, Osaka-shi (JP)

(73) Assignee: Sharp Kabushiki Kaisha, Osaka-shi, Osaka (JP)

(21) Appl. No.: 13/499,103

(22) PCT Filed: Sep. 14, 2010
(86) PCT No.: PCT/JP2010/065841

§ 371 Date: Mar. 29, 2012

(30) Foreign Application Priority Data
Sep. 30, 2009 (JP) 2009-226877

(51) Int. Cl. G09G 3/36; G06F 3/041; G06F 3/044

(52) U.S. Cl. 345/174; 345/173; 345/104

(57) ABSTRACT

Provided is a liquid crystal panel equipped with a touch sensor function that can detect pressing force. Multiple displacement detection units (30) are provided between a pair of substrates (31, 32) arranged opposing each other and output a signal due to displacement of one of the substrates. A displacement point detection unit (3) binarily detects whether the one substrate has become displaced at each position of the displacement detection units (30) based on the signals output from the displacement detection units (30). A coordinate detection unit (4) detects the coordinates of, among the displacement detection units (30), the displacement detection units for which the displacement point detection unit (3) detected that the one substrate became displaced, and outputs pressing force position information. A displacement point counting unit (5) counts the number of displacement detection units for which the displacement point detection unit (3) detected that displacement occurred among the displacement detection units (30), and a pressing force deriving unit (6) outputs information regarding a pressing force intensity based on the number of displacement detection units counted by the displacement point counting unit (5).

### REFERENCE TO RELATED APPLICATIONS

This application is the national stage under 35 USC 371 of International Application No. PCT/JP2010/065841, filed Sep. 14, 2010, which claims priority from Japanese Patent Application No. 2009-226877, filed Sep. 30, 2009, the entire contents of which are incorporated herein by reference.

### FIELD OF THE INVENTION

The present invention relates to a liquid crystal panel equipped with a touch sensor function. In particular, the present invention relates to a liquid crystal panel equipped with a touch sensor function that can detect touch pressure (pressing force) in addition to a touch position (pressing force position).

### BACKGROUND OF THE INVENTION

Image display devices that can also be used as an information input device by providing the image display surface with a touch sensor function have been put into practical use. With such image display devices, generally a position (touch position) on the image display surface that has been touched by a user's finger, touch pen, or the like is detected.

In recent years, there have been proposals for an information input device in which an image display device such as a liquid crystal panel is equipped with a touch panel having a touch sensor function that can detect the intensity of pressing force in addition to a touch position and issue different instructions according to the pressing force intensity (e.g., see JP H11-203044A, JP H11-203044A, and JP 2008-276369A).

Meanwhile, there is also known to be a liquid crystal panel equipped with a touch sensor function in which detection elements for realizing the touch sensor function are incorporated in the liquid crystal panel. Known examples of detection systems for such a liquid crystal panel include the in-cell microswitch system (hereinafter, simply referred to as the “microswitch system”) and the liquid crystal capacitance system.

With a microswitch-system liquid crystal panel, contact and conduction between switch electrodes in liquid crystal cells is detected when a load has been applied to the liquid crystal panel. JP 2007-58070A discloses a microswitch-system liquid crystal panel equipped with a touch sensor function that can detect pressing force. The following describes the principle of pressing force detection in the microswitch-system liquid crystal panel disclosed in JP 2007-58070A with reference to FIG. 15.

Pixel electrodes that apply a voltage to liquid crystal 901, thin film transistors (TFTs) connected to the pixel electrodes, and the like are formed on a TFT substrate 902, a counter electrode is formed on a counter substrate 903, and the TFT substrate 902 and the counter substrate 903 are arranged opposing each other with a spacer 904 sandwiched therebetween. A first projecting electrode 905a, a second projecting electrode 905b, and a third projecting electrode 905c that have different heights are formed on the TFT substrate 902. When a finger 906 or a touch pen 907 presses the surface of the counter substrate 903, the counter substrate 903 flexes, and the gap between the counter substrate 903 and the TFT substrate 902 becomes narrower. At this time, the flexure amount of the counter substrate 903 changes according to the pressing force intensity. When the pressing force is weak, the counter electrode of the counter substrate 903 comes into contact with only the tallest first projecting electrode 905a, and when the pressing force becomes stronger, the counter electrode comes into contact with the second projecting electrode 905b and the third projecting electrode 905c as well. Accordingly, the pressing force intensity can be detected by a change in the types of projecting electrodes with which the counter electrodes comes into contact.

A liquid crystal capacitance-system liquid crystal panel equipped with a touch sensor function is disclosed in JP 2008-58925A. The following describes the principle of detection in the liquid crystal capacitance-system liquid crystal panel equipped with a touch sensor function with reference to FIGS. 16A and 16B. A pair of substrates 912 and 913 sandwich liquid crystal 911, and electrodes are formed on the substrates so as to oppose each other, thus forming an electrostatic capacitance in a liquid crystal cell. As shown in FIG. 16B, when the substrate 912 on the display surface side is pressed, the gap between the substrates 912 and 913 becomes narrower, and the electrostatic capacitance changes. A control circuit or the like converts this change in the electrostatic capacitance into a change in current value using a thin film transistor, an integrating circuit integrates current values in a predetermined time period, and the resulting value is output as a detected voltage. Specifically, since the electrostatic capacitance changes according to the pressing force intensity, the detected voltage also changes according to the pressing force intensity. Accordingly, the pressing force intensity can be detected by detecting the intensity of the detected voltage.

### SUMMARY OF THE INVENTION

With the microswitch-system liquid crystal panel equipped with a touch sensor function shown in FIG. 15, the heights of the projecting electrodes 905a, 905b, and 905c need to be changed in order to adjust the pressing force detection sensitivity. This then necessitates a change in the projecting electrode manufacturing conditions. Specifically, it is necessary to create a new mask to be used in the projecting electrode manufacturing step, and change the exposure conditions in photolithography, thus making the manufacturing of the projecting electrodes troublesome and causing a rise in manufacturing cost. It is therefore difficult for the sensitivity of the liquid crystal panel equipped with a touch sensor function to be adjusted according to the user and the usage scenario.

Also, the dimensional accuracy of the heights of the projecting electrodes 905a, 905b, and 905c directly affects pressing force detection sensitivity. Accordingly, due to dimensional variation that unavoidably occurs in projecting electrode manufacturing, it is not possible to avoid differences in pressing force detection sensitivity between each product.

Here, raising the resolution of pressing force detection necessitates an increase in the number of types of projecting electrodes having different heights. In order to achieve this, dimensional variation in the projecting electrodes needs to be made very small in projecting electrode manufacturing. However, there is a limit on how low dimensional variation can be reduced, and the number of types of projecting electrodes that can actually be manufactured is also limited, and therefore there is a limit on resolution in pressing force detection.

For this reason, a liquid crystal panel equipped with a touch sensor function that can resolve the aforementioned conventional problems is provided. Specifically, provided is a liquid crystal panel equipped with a touch sensor function in which the sensitivity of pressing force detection can be adjusted without changing a manufacturing step.

A liquid crystal panel equipped with a touch sensor function according to an embodiment of the present invention includes: a touch panel that includes a pair of substrates arranged opposing each other and a plurality of displacement detection units that are provided between the pair of substrates and output a signal due to one substrate out of the pair of substrates being pressed and becoming displaced; a displacement point detection unit that, based on the signals output from the plurality of displacement detection units, binarily detects whether the one substrate has become displaced at each position of the plurality of displacement detection units; a coordinate detection unit that derives coordinates of, among the plurality of displacement detection units, a displacement detection unit for which the displacement point detection unit detected that the one substrate became displaced, and outputs information regarding the position of the pressing; a displacement point counting unit that counts the number of displacement detection units for which the displacement point detection unit detected that displacement occurred among the plurality of displacement detection units; and a pressing force deriving unit that outputs information regarding a pressing force intensity based on the number of displacement detection units counted by the displacement point counting unit.

According to this embodiment of the present invention, it is possible to provide a liquid crystal panel equipped with a touch sensor function that can detect the intensity of pressing force in addition to a pressing force position. Moreover, it is possible to adjust the sensitivity of pressing force detection without changing a manufacturing step.

### BRIEF DESCRIPTION OF DRAWINGS

FIG. 1 is a block diagram of a touch sensor unit of a liquid crystal panel equipped with a touch sensor function according to Embodiment 1 of the present invention.

FIG. 2A is a circuit diagram of a pixel including a microswitch-system displacement detection unit in the liquid crystal panel equipped with a touch sensor function according to Embodiment 1 of the present invention.

FIG. 2B is a cross-sectional diagram showing a schematic configuration of the displacement detection unit in FIG. 2A.

FIG. 3A is a block diagram of a displacement point detection unit that processes an output signal from the displacement detection unit in the liquid crystal panel equipped with a touch sensor function according to Embodiment 1 of the present invention.

FIG. 3B is a timing chart for illustrating operations of the displacement point detection unit.

FIG. 4 is a cross-sectional diagram of a counter substrate configuring the liquid crystal panel equipped with a touch sensor function according to Embodiment 1 of the present invention.

FIG. 5 is a side view showing how the liquid crystal panel equipped with a touch sensor function according to Embodiment 1 of the present invention is subjected to a pressing test with a touch pen.

FIG. 6A is a diagram showing a distribution of displacement points for which counter substrate displacement was detected in a state of no pressing force from a touch pen in a working example of the liquid crystal panel equipped with a touch sensor function according to the present invention.

FIG. 6B is a diagram showing a distribution of displacement points for which counter substrate displacement was detected when a pressing force of 1.0 was applied with the touch pen in the working example of the liquid crystal panel equipped with a touch sensor function according to the present invention.

FIG. 6C is a diagram showing a distribution of displacement points for which counter substrate displacement was detected when a pressing force of 1.2 was applied with the touch pen in the working example of the liquid crystal panel equipped with a touch sensor function according to the present invention.

FIG. 6D is a diagram showing a distribution of displacement points for which counter substrate displacement was detected when a pressing force of 1.4 was applied with the touch pen in the working example of the liquid crystal panel equipped with a touch sensor function according to the present invention.

FIG. 6E is a diagram showing a distribution of displacement points for which counter substrate displacement was detected when a pressing force of 1.8 was applied with the touch pen in the working example of the liquid crystal panel equipped with a touch sensor function according to the present invention.

FIG. 6F is a diagram showing a distribution of displacement points for which counter substrate displacement was detected when a pressing force of 2.7 was applied with the touch pen in the working example of the liquid crystal panel equipped with a touch sensor function according to the present invention.

FIG. 6G is a diagram showing a distribution of displacement points for which counter substrate displacement was detected when a pressing force of 4.5 was applied with the touch pen in the working example of the liquid crystal panel equipped with a touch sensor function according to the present invention.

FIG. 7A is a cross-sectional diagram for illustrating how the size of a displacement area changes according to pressing force intensity.

FIG. 7B is a cross-sectional diagram for illustrating how the size of the displacement area changes according to pressing force intensity.

FIG. 8 is a diagram showing a relationship between the number of displacement points and pressing force in the working example of the liquid crystal panel equipped with a touch sensor function.

FIG. 9 is a diagram showing a relationship between the number of displacement points constituting the greatest width in the X axis direction of the displacement area and pressing force in the working example of the liquid crystal panel equipped with a touch sensor function.

FIG. 10 is a diagram showing a relationship between the number of displacement points constituting the greatest width in the Y axis direction of the displacement area and pressing force in the working example of the liquid crystal panel equipped with a touch sensor function.

FIG. 11A is a cross-sectional diagram for illustrating how displacement points (the size of a displacement area) change according to the size of a finger.

FIG. 11B is a cross-sectional diagram for illustrating how displacement points (the size of a displacement area) change according to the size of a finger.

FIG. 12 is a block diagram of a touch sensor unit of a liquid crystal panel equipped with a touch sensor function according to Embodiment 4 of the present invention.

FIG. 13A is a cross-sectional diagram showing how displacement points (the size of a displacement area) change when a narrow finger has first lightly touched a touch surface.

FIG. 13B is a cross-sectional diagram showing how displacement points (the size of a displacement area) change when a narrow finger has strongly pressed against the touch surface.

FIG. 14A is a cross-sectional diagram showing how displacement points (the size of a displacement area) change when a wide finger has first lightly touched a touch surface.

FIG. 14B is a cross-sectional diagram showing how displacement points (the size of a displacement area) change when a wide finger has strongly pressed against the touch surface.

FIG. 15 is a cross-sectional diagram for illustrating a principle of pressing force detection in a conventional microswitch-system liquid crystal panel equipped with a touch sensor function.

FIG. 16A is a cross-sectional diagram showing a schematic configuration of a conventional liquid crystal capacitance-system liquid crystal panel equipped with a touch sensor function.

FIG. 16B is a cross-sectional diagram for illustrating a principle of pressing force detection in the conventional liquid crystal capacitance-system liquid crystal panel equipped with a touch sensor function.

### DETAILED DESCRIPTION OF THE INVENTION

A liquid crystal panel equipped with a touch sensor function according to an embodiment of the present invention includes: a touch panel that includes a pair of substrates arranged opposing each other and a plurality of displacement detection units that are provided between the pair of substrates and output a signal due to one substrate out of the pair of substrates being pressed and becoming displaced; a displacement point detection unit that, based on the signals output from the plurality of displacement detection units, binarily detects whether the one substrate has become displaced at each position of the plurality of displacement detection units; a coordinate detection unit that outputs coordinates of, among the plurality of displacement detection units, a displacement detection unit for which the displacement point detection unit detected that the one substrate became displaced, and outputs information regarding the position of the pressing; a displacement point counting unit that counts the number of displacement detection units for which the displacement point detection unit detected that displacement occurred among the plurality of displacement detection units; and a pressing force deriving unit that outputs information regarding a pressing force intensity based on the number of displacement detection units counted by the displacement point counting unit (first configuration).

According to the above configuration, the liquid crystal panel equipped with a touch sensor function includes the displacement point counting unit and the pressing force deriving unit, and therefore can resolve the problems of the above-described conventional configurations. Specifically, the sensitivity of pressing force detection can be adjusted by changing a setting in the pressing force deriving unit, without changing the heights of projecting electrodes as in the conventional configurations. More specifically, by changing the setting of a threshold value in the pressing force deriving unit for the number of displacement detection units counted by the displacement point counting unit, it is possible to easily change the relationship between the number of displacement detection units and the pressing force intensity, thus enabling the sensitivity of pressing force detection to be easily adjusted.

Also, even if variation occurs in the pressing force intensity according to which a signal is output by the displacement detection units due to dimensional variation in manufacturing, pressing force intensity can be precisely detected by adjusting the relationship between the number of displacement detection units and the pressing force intensity by changing a setting in the pressing force deriving unit. Furthermore, the respective numbers of displacement detection units corresponding to pressing force intensities, that is to say, the resolution, can be freely set according to the pressing force deriving unit, thus enabling easily raising the resolution of pressing force detection.

It is preferable that in the first configuration, the plurality of displacement detection units each include a pair of electrodes respectively formed on mutually opposing faces of the pair of substrates and output the signal in a case where the pair of electrodes have come into contact with each other due to displacement of the one substrate (second configuration). This enables configuring microswitch-system displacement detection units.

Alternatively, in the first configuration, the plurality of displacement detection units may each include an electrostatic capacitance configured by a pair of electrodes respectively formed on mutually opposing faces of the pair of substrates and output the signal in accordance with a change in the electrostatic capacitance that occurs due to displacement of the one substrate (third configuration). This enables configuring liquid crystal capacitance-system displacement detection units.

In any one of the first to third configurations, the displacement point counting unit may count the total number of displacement detection units for which the displacement point detection unit detected that displacement occurred among the plurality of displacement detection units (fourth configuration). This enables more accurately performing pressing force detection.

Alternatively, in any one of the first to third configurations, the plurality of displacement detection units may be arranged so as to be aligned in two orthogonal alignment directions, and the displacement point counting unit may count the greatest number of displacement detection units aligned along one direction out of the two alignment directions among the displacement detection units for which the displacement point detection unit detected that displacement occurred (fifth configuration). This enables shortening the time for counting the number of displacement detection units and the subsequent arithmetic operation time.

In any one of the first to fifth configurations, it is preferable that the pressing force deriving unit compares the number of displacement detection units counted by the displacement point counting unit with a relationship between the number of displacement detection units and pressing force that has been set in advance, and outputs the information regarding the pressing force intensity in accordance with the number of displacement detection units (sixth configuration).

Since the number of displacement detection units for which displacement was detected and the pressing force are correlated with each other, pressing force detection can be performed accurately and swiftly by comparing the number of displacement detection units counted by the displacement point counting unit and values that have been set in advance, and outputting information regarding the pressing force intensity in accordance with the number of displacement detection units.

Alternatively, in any one of the first to fifth configurations, the pressing force deriving unit may include: a storage unit that stores the number of displacement detection units counted by the displacement point counting unit at the start of a pressing operation; and a comparison calculation unit that performs a comparison calculation on the number of displacement detection units counted by the displacement point counting unit during a pressing operation and the number of displacement detection units stored in the storage unit (seventh configuration). This enables reducing differences in pressing force detection precision caused by finger size, for example.

Embodiments of the present invention are described below with reference to the attached drawings. Note that the present invention is, needless to say, not intended to be limited to the following embodiments. For the sake of convenience in the description, the drawings that are referenced in the following description show simplifications of, among the constituent members of the embodiments, only relevant members that are necessary for describing the present invention. The present invention can therefore include arbitrary constituent members not shown in the following drawings. Also, regarding the dimensions of the members in the following drawings, the dimensions of the actual constituent members, the ratios of the dimensions of the members, and the like are not shown faithfully.

### Embodiment 1

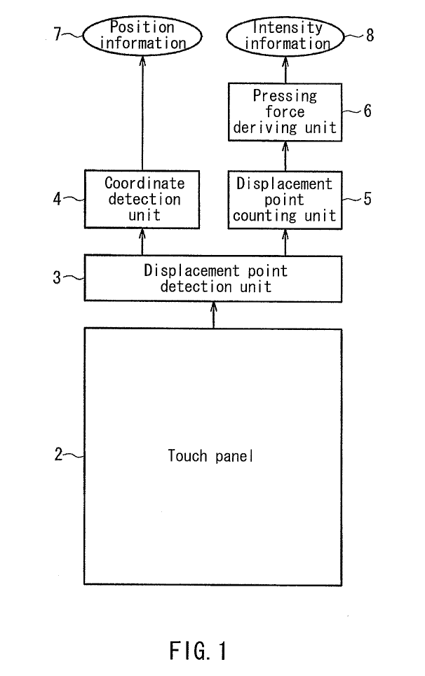

FIG. 1 is a block diagram of a touch sensor unit of a liquid crystal panel equipped with a touch sensor function according to Embodiment 1.

The touch sensor unit of the liquid crystal panel equipped with a touch sensor function of Embodiment 1 includes a touch panel 2, a displacement point detection unit 3, a coordinate detection unit 4, a displacement point counting unit 5, and a pressing force deriving unit 6.

The touch panel 2 includes a pair of opposing substrates and a plurality of displacement detection units provided between the pair of substrates.

As the pair of substrates, it is possible to use, for example, a pair of light-transmitting substrates that configure part of the liquid crystal panel and sandwich liquid crystal.

When the surface (touch surface, which is normally the image display surface) of one substrate (the touch substrate) out of the pair of substrates is pressed, the displacement detection units output a signal in accordance with displacement of the touch substrate (i.e., a change in the gap between the pair of substrates) that occurs due to the pressing. The displacement detection units are arranged discretely in a plane parallel with the touch surface of the touch panel 2, preferably in a lattice-point configuration. For example, the displacement detection units may be provided one for each of red, green, and blue color picture elements in the liquid crystal panel, one for each pixel (color pixel) constituted by three picture elements, namely a red, a green, and a blue picture element, or one for multiple pixels.

There are no particular limitations on the specific configuration of the displacement detection units, and it is possible to use a microswitch system or a liquid crystal capacitance system, for example.

The microswitch system is a system in which contact and conduction between a pair of electrodes (microswitches) formed on respective opposing surfaces of the pair of substrates due to pressing is detected. There are no limitations on the specific configuration of the microswitch system, and it is possible to use, for example, a well-known microswitch system (e.g., see JP 2006-133788A and JP 2008-65302A).

The liquid crystal capacitance system is a system in which an electrostatic capacitance is formed by a pair of electrodes formed on opposing surfaces of a pair of substrates so as to oppose each other and sandwich a liquid layer, and change in the electrostatic capacitance due to narrowing of the gap between the pair of electrodes caused by pressing is detected. There are no limitations on the specific configuration of the liquid crystal capacitance system, and it is possible to use, for example, a well-known liquid crystal capacitance system (e.g., see JP 2008-58925A, JP 2007-128514A, and JP 2007-48275A).

The displacement point detection unit 3 binarily detects the presence/absence of displacement of the touch substrate (i.e., change in the gap between the pair of substrates) at the positions of each of the displacement detection units based on the signals output from the displacement detection units. The displacement point detection unit 3 binarizes the voltages of detection lines connected to the displacement detection units by comparison with a reference value (threshold value) set in a comparator. For example, the displacement point detection unit 3 determines that the touch substrate was displaced (touched) if an output voltage greater than the threshold value was obtained from a displacement detection unit, and determines that the touch substrate was not displaced (not touched) if otherwise. The displacement point detection unit 3 makes this determination for each of the displacement detection units.

The coordinate detection unit 4 detects the coordinates of, from among the displacement detection units, each displacement detection unit for which the displacement point detection unit 3 detected that the touch substrate was displaced, and derives information (position information) 7 regarding pressed positions. There are no particular limitations on the method of deriving the pressed position information 7, and it is possible to use a well-known method, for example.

The above-described touch panel 2, displacement point detection unit 3, and coordinate detection unit 4 can be constituted similarly to those of a conventional well-known touch panel. In this embodiment, the liquid crystal panel further includes a displacement point counting unit 5 and a pressing force deriving unit 6.

The displacement point counting unit 5 counts and outputs the number of displacement detection units for which the displacement point detection unit 3 detected that the touch substrate was displaced among the displacement detection units.

The pressing force deriving unit 6 outputs information (intensity information) 8 regarding pressing force intensity based on the number of displacement detection units that was counted by the displacement point counting unit 5. For example, the pressing force deriving unit 6 compares the number of displacement detection units for which touch substrate displacement was detected with a pre-set relationship between pressing force intensities and respective numbers of displacement detection units for which displacement was detected, and outputs the information 8 regarding pressing force intensity. This enables realizing a touch sensor function that can detect pressing force in addition to a touch position.

The following is a specific description of the various units.

First, a description will be given of the displacement detection units formed in the touch panel 2.

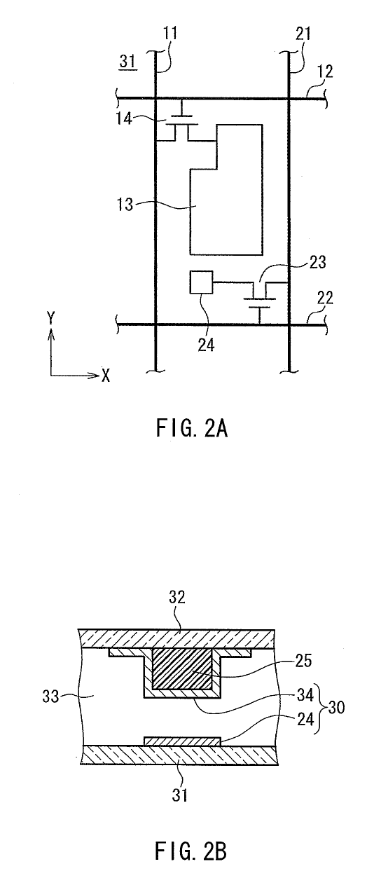

FIG. 2A is a circuit diagram of a pixel including a microswitch-system displacement detection unit in the liquid crystal panel equipped with a touch sensor function according to Embodiment 1. FIG. 2B is a cross-sectional diagram showing the schematic configuration of the displacement detection unit in FIG. 2A.

As shown in FIG. 2A, source lines 11 that are parallel with the Y axis and receive application of display data and gate lines 12 that are parallel with the X axis and are for performing sequential scanning are formed in a matrix configuration on a TFT substrate 31 (see the later-described FIG. 2B) of the liquid crystal panel. A pixel driving thin film transistor (hereinafter, referred to as a “pixel driving TFT”) 14 connected to a picture element electrode 13 is formed at positions where the source lines 11 and the gate lines 12 intersect. There are no particular limitations on the above configuration, and it is possible to use the same configuration as that of a well-known liquid crystal panel, for example.

In the present embodiment, detection lines 21 that are parallel with the Y axis, and scan lines 22 that are parallel with the X axis are furthermore formed on the TFT substrate 31, and a displacement detection thin film transistor (hereinafter, referred to as a “detection TFT”) 23 and a contact pad 24 are formed at positions where the detection lines 21 and the scan lines 22 intersect. The gate electrode of each detection TFT 23 is connected to a scan line 22, and the source electrode of each detection TFT 23 is connected to a contact pad 24, and the drain electrode of each detection TFT 23 is connected to a detection line 21.

FIG. 2B is a cross-sectional view in the case where the liquid crystal panel has been sectioned along a plane passing through a contact pad 24. The TFT substrate 31 and a counter substrate 32 serving as the touch substrate are arranged so as to oppose each other and sandwich liquid crystal 33. The contact pad 24 is formed on the surface of the TFT substrate 31 that is on the side facing the counter substrate 32. A protruding portion 25 is formed on the counter substrate 32 at a position opposing the contact pad 24. A transparent counter electrode 34 is formed on the counter substrate 32 in a region opposing the region of the TFT substrate 31 where the many picture element electrodes 13 are formed in a matrix, so as to cover the protruding portion 25.

The contact bad 24 formed on the TFT substrate 31 and the counter electrode 34 formed on the counter substrate 32 configure a microswitch-system displacement detection unit 30.

Although alignment films are formed on the surface of the TFT substrate 31 that is on the side facing the counter substrate 32, they are not shown in FIG. 2B. Also, alignment films and color filter layers including red, green, and blue color layers (color filters) as well as a black matrix for preventing the leakage of light between these color layers are formed on the side of the counter substrate 32 that is on the side facing the TFT substrate 31, but they are not shown in FIG. 2B. Furthermore, although not shown, a pair of polarizing films are formed on the outer sides of the TFT substrate 31 and the counter substrate 32 so as to sandwich the TFT substrate 31 and the counter substrate 32.

When pressing force from a finger, a touch pen, or the like is applied to the surface of the counter substrate 32 that is on the side opposite to the TFT substrate 31, the counter substrate 32 flexes such that the position of the counter substrate 32 changes, and the gap between the counter substrate 32 and the TFT substrate 31 becomes narrower. Then, when the counter electrode 34 comes into contact with the contact pad 24, the counter voltage applied to the counter electrode 34 is applied to the contact pad 24. By detecting the counter voltage applied to this contact pad 24 via the detection line 21, it is possible to detect that the counter substrate 32 has become displaced, that is to say, has been touched with a touch pen, finger, or the like, at the position of that contact pad 24.

Specifically, the potential of the scan lines 22 is sequentially switched to H (High). When the potential H is applied to a scan line 22, the TFTs 23 connected to that scan line 22 enter the on state for the period in which the potential H is applied, and the counter voltage applied to the contact pads 24 are output to the detection lines 21. By detecting the output voltage of each of the detection lines 21, it is possible to detect the positions at which the counter substrate 32 was displaced over the scan line 22 to which the potential H was applied. By sequentially switching (scanning) the scan line 22 to which the potential H is applied among the scan lines 22, it is possible to detect positions at which the counter substrate 32 was displaced in a whole screen.

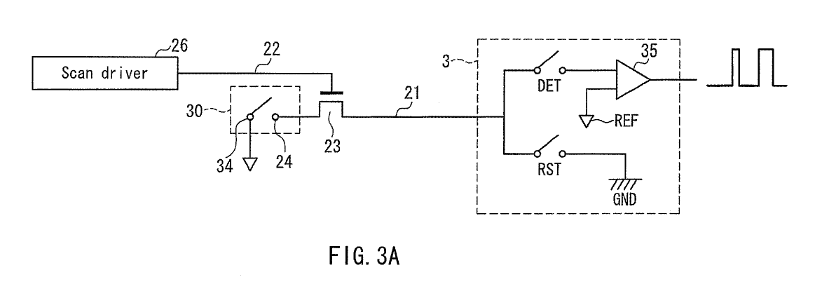

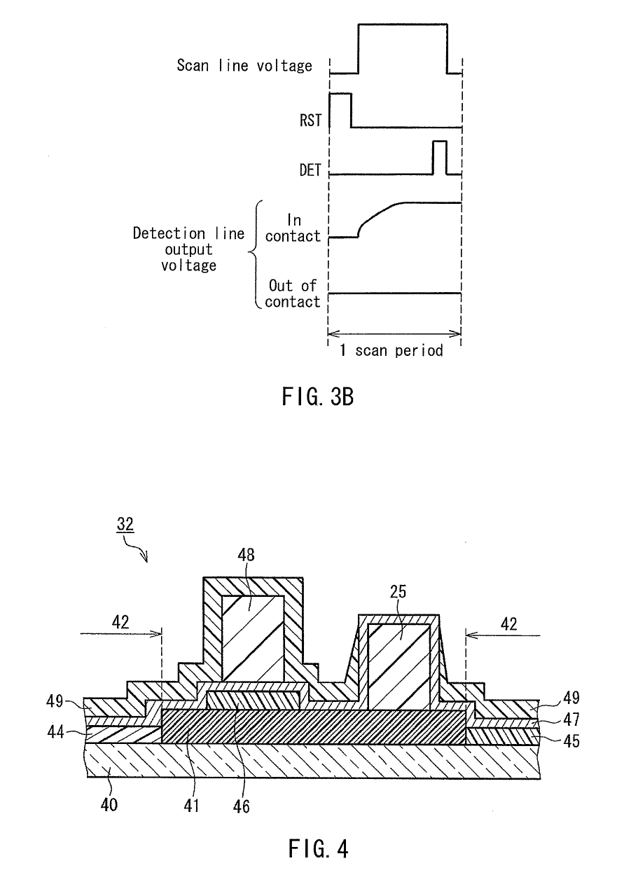

FIG. 3A is a block diagram of the displacement point detection unit 3 for processing output the output signal from the displacement detection units 30, and FIG. 3B is a timing chart showing an example of operations performed by the displacement point detection unit 3. Operations performed on the displacement point detection unit 3 will be described below with reference to these figures.

First, the potential of the detection lines 21 is reset to GND due to a reset switch RST being switched on.

Next, the potential H is applied to the scan line 22 that is connected to a scan driver 26. As result, the detection TFT 23 enters the on state. At this time, if the counter electrode 34 and the contact pad 24 of the displacement detection unit 30 that is connected to this detection TFT 23 come into contact with each other (“in contact”), the counter potential applied by the counter electrode 34 is output to the detection line 21 via the contact pad 24. On the other hand, when the counter electrode 34 and the contact pad 24 are not in contact (“out of contact”), the voltage of the detection line 21 remains at GND.

Next, a detection switch DET is switched on. A comparator 35 compares the voltage of the detection line 21 with a reference voltage REF that has been set in advance. Then, in the case where the voltage of the detection line 21 is higher than the reference voltage REF, it is determined that the counter substrate 32 was displaced, and the voltage H (High) is output, and in the case where the voltage of the detection line 21 is lower than the reference voltage REF, it is determined that the counter substrate 32 was not displaced, and the voltage L (Low) is output.

As described above, the displacement point detection unit 3 including the comparator 35 binarily detects whether or not the counter substrate 32 was displaced at the positions of the displacement detection units 30.

The following describes a method for manufacturing the touch panel 2 including the displacement detection unit 30 shown in FIG. 2B. Note that needless to say, the following manufacturing method is one example, and there is no limitation to the following manufacturing method.

First, a description will be given of an example of a method of manufacturing the counter substrate 32 including the protruding portion 25 and the like as shown in FIG. 4.

First, a glass substrate 40 is prepared as the base material of the counter substrate 32. A substrate having light-transmitting characteristics such as silica glass can be used as the glass substrate 40.

A photosensitive resist layer containing a hydrophilic resin is formed on the glass substrate 40. This photosensitive resist layer is then exposed via a black matrix photomask, and thereafter developed, thus forming a black matrix pattern. Next, by bringing the black matrix pattern on the glass substrate 40 into contact with an electroless plating solution, metal particles are caused to precipitate in the pattern so as to cause blackening, thus forming a black matrix 41. The black matrix 41 has light transmission portions 42 serving as openings in which the later-described red, green, and blue color layers are to be formed. Furthermore, between adjacent light transmission portions 42, the black matrix 41 has a substantially rectangular region for the formation of the projecting portion 25 and a later-described photospacer 48.

Next, a resin film (dry film) having a red pigment dispersed therein is laminated in the entirety of a predetermined region on the glass substrate 40, and then exposure, developing, and baking (heating) are performed, thus forming a red color layer 43 (not shown) in the light transmission portion 42. Next, a resin film having a green pigment dispersed in a predetermined region is laminated over the entirety of the red color layer 43, and then exposure, developing, and baking (heating) are performed, thus forming a green color layer 44 in a light transmission portion 42 adjacent to the red color layer. Similarly, a blue color layer 45 is formed in the light transmission portion 42 that is between the green color layer and the red color layer. The red, green, and blue color layers are formed so as to be in an array of stripes with respect to each other. At this time, one color layer (in the present embodiment, the blue color layer 45) among the red, green, and blue color layers is also formed in a predetermined region within the substantially rectangular region of the black matrix 41, thus forming a spacer pedestal portion 46.

Note that the method for forming the red, green, and blue color layers is not limited to the above-described method of laminating resin films, and a configuration is possible in which, for example, the color layers are formed by photosensitive resin materials having pigments dispersed therein being applied to the entire surface of the glass substrate 32 by spin coating, slit coating, or the like. Furthermore, the order of formation of the red, green, and blue color layers is not limited to the above-described order, and another order is possible.

Next, a photolithography method is used to form the projecting portion 25 made up of a photosensitive resin or the like in the substantially rectangular region of the black matrix 41.

Next, a transparent electrode 47 is formed by vapor depositing ITO (Indium Tin Oxide) on the black matrix 41, the color layers 43, 44, and 45, the spacer pedestal portion 46, and the projecting portion 25.

Next, a photolithography method is used to form the photospacer 48 made up of a photosensitive resin or the like on the transparent electrode 47 in the region of the spacer pedestal portion 46. The photospacer 48 is for maintaining a constant gap between the TFT substrate 31 and the counter substrate 32.

Next, an alignment film 49 is formed so as to cover the black matrix 41, the color layers 43, 44, and 45, the spacer pedestal portion 46, the projecting portion 25, and the photospacer 48.

Next, alignment processing is carried out on the alignment film 49 using the following technique that employs rubbing. First, the glass substrate 40 is fixed on a stage with the alignment film 49 facing upwards. Next, the surface of the alignment film 49 of the glass substrate 40 fixed on the stage is rubbed at a predetermined pressure with a cylindrical rubbing roller around which a rubbing cloth or the like is wrapped.

Lastly, the alignment film 49 on the projecting portion 25 is removed by a photolithography method and an ashing method.

Accordingly, the counter substrate 32 having the configuration shown in FIG. 4 is obtained.

Next is a description of an example of a method for forming the TFT substrate 31.

One difference from conventional TFT substrates in the present embodiment is that, as described above, the detection lines 21, the scan lines 22, the detection TFTs 23, and the contact pads 24 need to be formed on the TFT substrate 31 (see FIG. 2A). Note that the detection lines 21 and the scan lines 22 can be formed similarly to the source lines 11 and the gate lines 12, and the detection TFTs 23 can be formed similarly to the pixel driving TFTs 14. Also, the contact pads 24 can be formed similarly to the picture element electrodes 13. Accordingly, the TFT substrate 31 of the present embodiment can be manufactured by applying a conventionally well-known TFT substrate manufacturing method. Note that since it is necessary for the microswitch-system displacement detection units 30 to be configured by the contact pads 24 along with the counter electrodes 34 formed at the top of the projecting portions 25 of the counter substrate 32 (see FIG. 2B), attention needs to be given to the fact that exposure needs to be performed, unlike the picture element electrodes 13 covered by the alignment film.

The following describes a specific example of a method for manufacturing the TFT substrate 31 of the present embodiment.

First, a glass substrate is prepared as the base material of the TFT substrate 31. A substrate having light-transmitting characteristics such as silica glass can be used as the glass substrate.

A thin-film made of Ta or Al/Ti is formed on the glass substrate using a sputtering method, and then patterning is performed, thus forming a gate electrode.

Next, a gate insulating film made of SiNx is formed, and an a-Si semiconductor layer is formed by performing patterning.

Next, a drain electrode and a source electrode are formed.

Next, an SiNx film is formed as a channel protective film, and an interlayer insulating film is formed. Next, a contact hole is formed.

Next, the picture element electrode 13 serving as the transparent electrode and the contact pad 24 are formed by vapor-depositing ITO.

Next, the alignment film is provided, and alignment processing is carried out through rubbing.

Lastly, the alignment film on the contact pad 24 is removed by a photolithography method and an ashing method.

Accordingly, the TFT substrate 31 is obtained.

The counter substrate 32 and TFT substrate 31 obtained as described above are attached together using a well-known method, and the liquid crystal 33 is injected therebetween, thus obtaining the touch panel 2.

The following describes the touch sensor function of the liquid crystal panel equipped with a touch sensor function of the present embodiment having the above-described configuration.

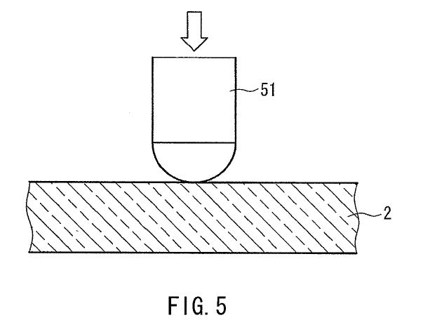

As shown in FIG. 5, the touch panel 2 of the present embodiment was manufactured, a touch pen 51 that has a hemispherical tip and a diameter of 0.8 mm was connected to the probe of a push-pull force gauge (DIGITAL FORCE GAUGE ZP-20N (IMADA), not shown), and the touch surface of the touch panel 2 was pressed in the perpendicular direction.

When a certain amount or more of pressing force is applied to the touch surface of the touch panel 2, the counter substrate 32 becomes displaced, a contact bad 24 and a counter electrode 24 that configure a displacement detection unit 30 come into contact (see FIG. 2B), and the counter potential applied to the counter electrode 34 is output from a detection line 21. As described with reference to FIGS. 3A and 3B, the displacement point detection unit 3 detects whether or not the counter substrate 32 was displaced, that is to say, whether or not a contact bad 24 and a counter electrode 34 came into contact, based on the potential of a detection line 21. The coordinate detection unit 4 derives the coordinates of the displacement detection unit 30 for which the displacement point detection unit 3 determined that the contact bad 24 and the counter electrode 34 came into contact (i.e., the counter substrate 32 became displaced).

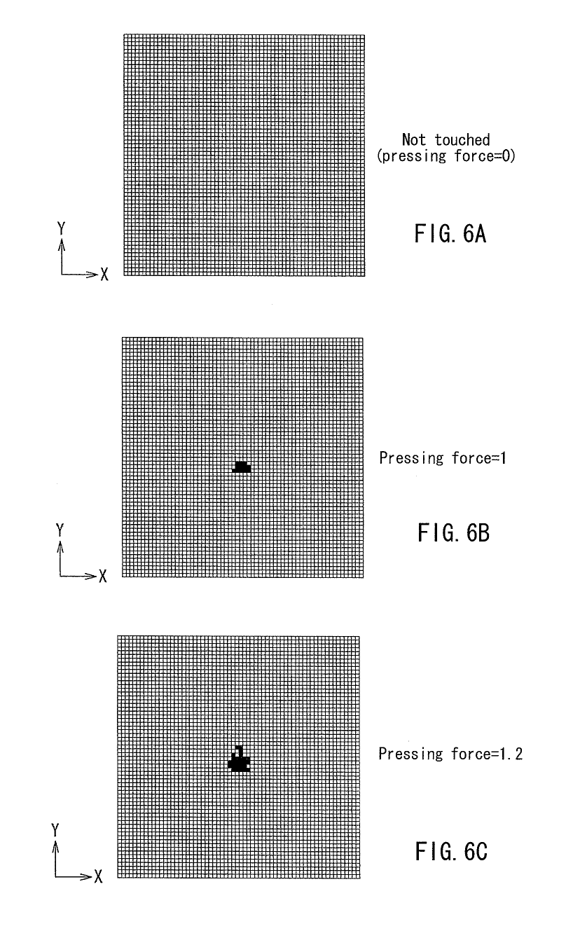

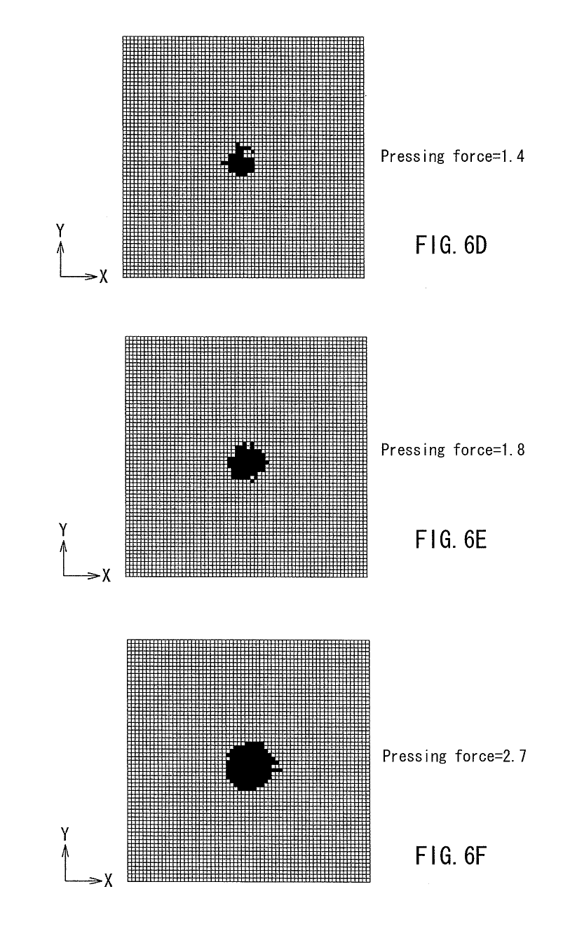

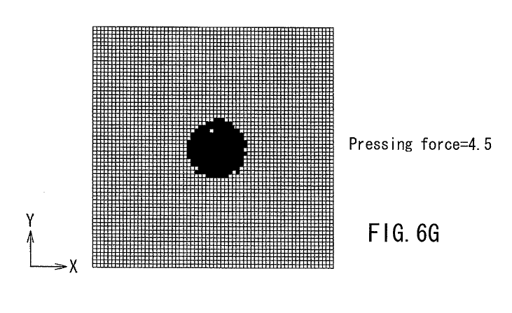

FIGS. 6A to 6G are diagrams showing the positions of the displacement detection units 30 for which the displacement point detection unit 3 determined that displacement occurred (hereinafter referred to as “displacement points”) when the touch pen 51 applied a predetermined pressing force in the center of the region in which the displacement detection units 30 are arranged in a matrix. Note that in FIGS. 6A to 6G, the displacement detection units 30 are arranged in a matrix having 64 points in the X axis direction and 64 points in the Y axis direction. Specifically, the displacement detection units 30 are arranged so as to be aligned in two orthogonal alignment directions.

FIG. 6A shows the case of no pressing force (not touched), and FIGS. 6B to 6G show results in the case of pressing force that gradually increases in the order of the figures. The pressing force values noted in the figures are numerical values indicating the intensity of the pressing force in the case of gradually increasing the pressing force from a state of no pressing force, letting the pressing force intensity when a displacement point was first detected be 1. In FIGS. 6A to 6G, the displacement points are colored solid black. It can be understood from FIGS. 6A to 6G that the area where the displacement points are distributed (hereinafter referred to as the “displacement area”) expands substantially concentrically as the pressing force increases.

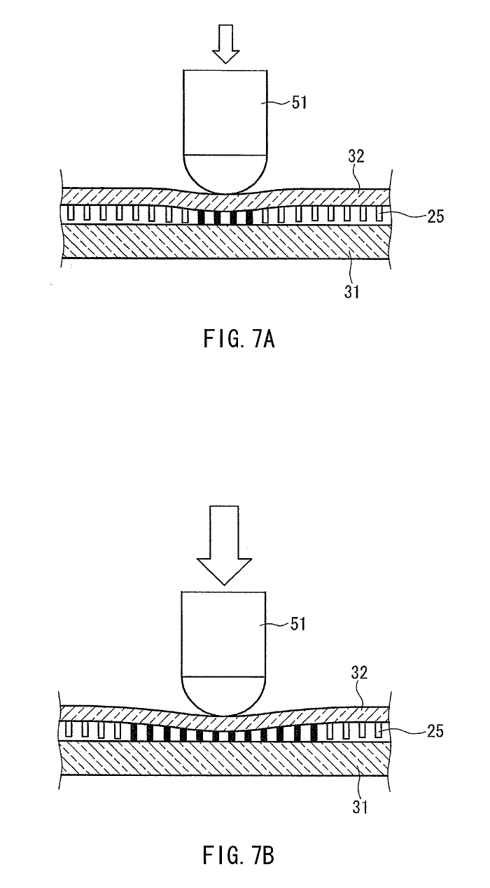

FIGS. 7A and 7B schematically show the deformation of the counter substrate 32 pressed by the touch pen 51. Among the projecting portions 25 formed on the counter substrate 32 in FIGS. 7A and 7B, the projecting portions 25 that configure the displacement detection units 30 for which the displacement point detection unit 3 determined that displacement occurred are colored solid black. On the other hand, in FIGS. 7A and 7B, the projecting portions 25 that configure the displacement detection units 30 for which the displacement point detection unit 3 determined that the counter substrate 32 was not displaced are shown hollowed. It can be understood that compared to FIG. 7A in which a relatively weak pressing force was applied, in FIG. 7B in which a relatively strong pressing force was applied, the region of deformation of the counter substrate 32 has expanded outside the region in the vicinity of the position of contact with the touch pen 51 as well, and the displacement area has expanded.

The relationship between the pressing force and the size of the displacement area can be arbitrarily changed by changing the thickness of the glass substrate 40 configuring the counter substrate 32, the gap between the contact pads 24 and the counter electrodes 34 (i.e., the height of the protruding portions 25, the liquid crystal cell gap, etc.), and the like. However, the relationship in which the displacement amount of the counter substrate 32 increases and the displacement area expands as the pressing force is increased holds regardless of the above-described conditions. Accordingly, the present embodiment is not limited to being applied to a touch panel 2 having a specific structure and specifications.

Note that with a touch pen having a small and constant area of contact with the touch surface, the relationship between the pressing force and the displacement area is determined uniquely, pressing force detection is simple, and there are fewer errors in pressing force detection, thus making such a touch pen preferable as the method of pressing. Note that as will be described later, pressing force detection is possible in the case of a finger as well.

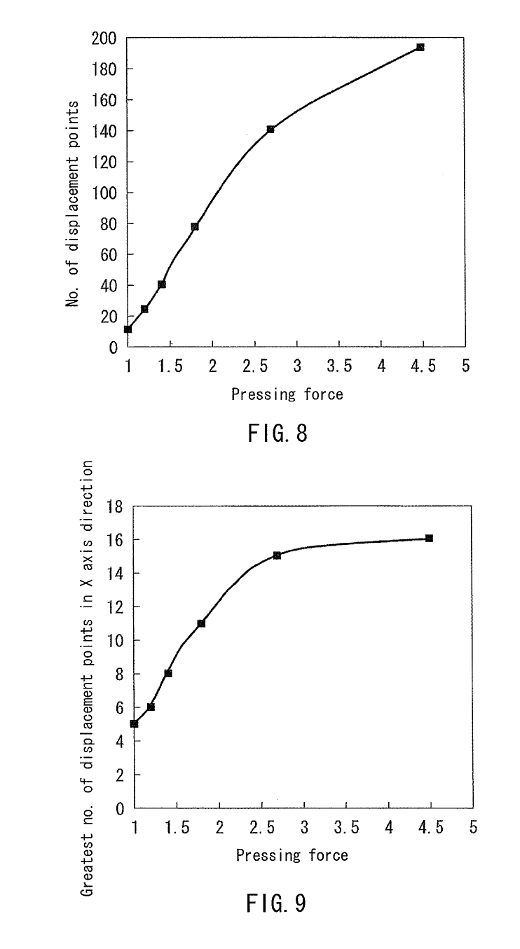

FIG. 8 is a diagram showing the relationship between pressing force and the number of displacement points obtained from FIGS. 6A to 6G. The number of displacement points on the vertical axis was obtained by counting the total number of displacement points in the displacement area. In the present embodiment, the displacement point counting unit 5 performs this displacement point counting.

It can be understood from FIG. 8 that, for example, the number of displacement points when the pressing force is 1.2 is double that when the pressing force is 1, and the pressing force of 1 and the pressing force of 1.2 can be distinguished from each other by counting the number of displacement points. Furthermore, the number of displacement points increases as the pressing force is increased to 1.4, 1.8, 2.7, and 4.5. Accordingly, it can be understood that the pressing force intensity can be detected by counting the number of displacement points.

The pressing force intensity can be detected by obtaining the relationship between the pressing force and the number of displacement points as shown in FIG. 8 in advance, and comparing the number of displacement points when pressing force was actually applied to the relationship that was obtained in advance. More specifically, stepwise levels of pressing force can be detected by setting at least one threshold value for the number of displacement points and comparing the number of displacement points when pressing force was applied to the at least one threshold value. Alternatively, the pressing force intensity can be obtained by setting an approximation expression that indicates the relationship between the pressing force and the number of displacement points as shown in FIG. 8 in advance, and substituting the number of displacement points when pressing force was applied into the approximation expression. In the present embodiment, the above-described threshold values and approximation expression are set in the pressing force deriving unit 6 in advance. Then, the pressing force deriving unit 6 derives the pressing force intensity using these threshold values and the approximation expression.

As described above, according to the present embodiment, the displacement point counting unit 5 that counts the number of displacement points and the pressing force deriving unit 6 that derives information regarding the pressing force intensity based on the number of displacement points are provided. This enables realizing a microswitch-system liquid crystal panel equipped with a touch sensor function that can detect pressing force intensity.

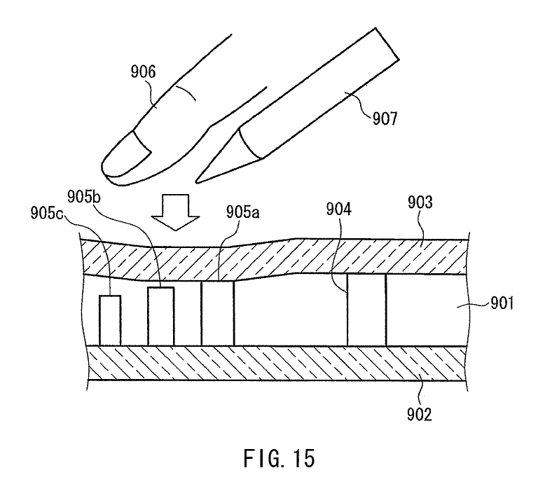

Also, by providing the displacement point counting unit 5 and the pressing force deriving unit 6 as described above, the above-described problems in the microswitch system disclosed in the aforementioned JP 2007-58070A (see FIG. 15) can be resolved as described below.

Specifically, with the configuration disclosed in JP 2007-58070A (see FIG. 15), adjusting the sensitivity of pressing force detection required changing the heights of the projecting electrodes, which required changing the manufacturing conditions for the projecting electrodes 905a, 905b, and 905c. In contrast, according to the present embodiment, the sensitivity of pressing force detection can be adjusted by changing a setting of the pressing force deriving unit 6, which is an external circuit, without changing the height of the projecting portions 25 (see FIG. 2B).

For example, the following is a specific description of the case of detecting three levels of pressing force (pressing force: weak, medium, and strong). In order to set weak pressing force to 1.2 or lower, strong pressing force to 1.8 or higher, and medium pressing force to between 1.2 and 1.8, according to FIG. 8 it is sufficient to set 25 and 78 as threshold values for the number of displacement points. In order to set weak pressing force to 1.4 or lower, strong pressing force to 2.7 or higher, and medium pressing force to between 1.4 and 2.7, according to FIG. 8 it is sufficient to set 25 and 141 as threshold values for the number of displacement points. In this way, the sensitivity of pressing force detection can be adjusted through the setting of the threshold values for the number of displacement points. Accordingly, there is no need to change a manufacturing step in order to perform sensitivity adjusting as with the configuration disclosed in JP 2007-58070A (see FIG. 15), and the sensitivity can be easily adjusted according to the user and the usage scenario.

Also, the configuration disclosed in JP 2007-58070A (see FIG. 15) has the problem that the pressing force detection sensitivity differs for each product due to dimensional variation that unavoidably occurs in the manufacturing of the projecting electrodes 905a, 905b, and 905c. In contrast, according to the present embodiment, variation in the height of the projecting portions 25 (see FIG. 2B) can be corrected by changing a setting of the pressing force deriving unit 6, which is an external circuit.

For example, consider the case where the projecting portions 25 have been formed with a height greater than the design value due to dimensional variation. In this case, the gap between the contact bad 24 and the counter electrode 34 becomes narrower, and the contact bad 24 and the counter electrode 34 come into contact even when the displacement amount of the counter substrate 32 is less than the design value. Accordingly, the number of pressed displacement points is higher than that in FIG. 8 with respect to the same pressing force. For example, in the case of determining that the pressing force is weak when the pressing force is 1.2 or lower, if the height of a projecting portion 25 is the design value, according to FIG. 8 it is sufficient to set the threshold value for the number of displacement points to 25. However, in the case where the height of the projecting portions 25 is greater than the design value, it is possible that, for example, the number of pressed points is 25 when the pressing force is 1, the number of pressed points is 41 when the pressing force is 1.2, and the number of pressed points is 78 when the pressing force is 1.4. In such a case, it is sufficient to change the threshold values for the number of displacement points to 41.

In this way, in the step of inspecting the liquid crystal panel equipped with a touch sensor function, it is sufficient to obtain the relationship between the pressing force and the number of displacement points for each product, and if there is a difference from a design value, to adjust the pressing force detection sensitivity by changing the threshold value settings in the pressing force deriving unit 6. Merely doing this enables easily correcting dimensional variation in the projecting portions 25.

Furthermore, with the configuration disclosed in JP 2007-58070A (see FIG. 15), raising the pressing force detection resolution requires an increase in the number of types of projecting electrodes with different heights, and in reality there is a limit to the number of types. In contrast, according to the present embodiment, the pressing force detection resolution can be easily raised by changing a setting of the pressing force deriving unit 6, which is an external circuit. For example, FIGS. 6A and 6G show that the number of displacement points changes in accordance with changing the pressing force in six levels. Accordingly, the pressing force can be detected with six levels of resolution by appropriately setting threshold values in the pressing force deriving unit 6. As described above, in view of the fact that the number of displacement points increases when the pressing force is increased, a resolution higher or lower than six levels can also be realized by arbitrarily setting the number of threshold values.

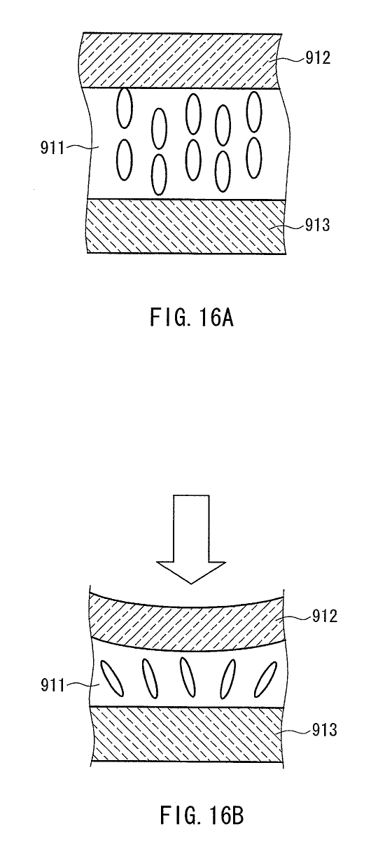

The above description is directed to a liquid crystal panel equipped with a touch sensor function that includes microswitch-system displacement detection units 30. However, the liquid crystal panel equipped with a touch sensor function of the present invention may include liquid crystal capacitance-system displacement detection units. With the liquid crystal capacitance system, the detected voltage, which changes according to a change in the electrostatic capacitance configuring a displacement detection unit, is binarized by being compared by the displacement point detection unit 3 with the reference value (threshold value) set in the comparator. Accordingly, signal processing in the later stage coordinate detection unit 4, displacement point counting unit 5, and pressing force deriving unit 6 can be performed similarly to the case of the microswitch system. As a result, the present embodiment resolves a problem in the conventional liquid crystal capacitance system disclosed in the aforementioned JP 2008-58925A (see FIG. 16), that is to say, the problem of being readily subjected to the influence of noise due to processing a detected voltage in its original analog amount state, thus making it difficult to accurately detect the pressing force intensity.

### Embodiment 2

In Embodiment 1, the displacement point counting unit 5 counts the total number of displacement points that constitute the two-dimensionally expanding displacement area shown in FIGS. 6A to 6G. In contrast, in Embodiment 2, the displacement point counting unit 5 counts the number of displacement points that constitute the greatest width in the X axis direction of the displacement area. Specifically, the displacement point counting unit 5 counts the number of displacement points aligned in the X axis direction at the Y axis direction position where the width in the X axis direction of the displacement area is the greatest.

FIG. 9 is a diagram showing the relationship between the number of displacement points constituting the greatest width in the X axis direction of the displacement area (the greatest number of displacement points in the X axis direction) and the pressing force, which was obtained from FIGS. 6A to 6G. It can be understood from FIG. 9 that, for example, the greatest number of displacement points in the X axis direction when the pressing force is 1.4 is 1.6 times that when the pressing force is 1, and the pressing force of 1 and the pressing force 1.4 can be distinguished from each other by counting the greatest number of displacement points in the X axis direction. Furthermore, the greatest number of displacement points in the X axis direction increases as the pressing force is increased to 1.8, 2.7, and 4.5. It can be understood from the above that the intensity of pressing force can be detected by counting the greatest number of displacement points in the X axis direction.

The pressing force intensity can be detected by obtaining the relationship between the pressing force and the greatest number of displacement points in the X axis direction as shown in FIG. 9 in advance, and comparing the greatest number of displacement points in the X axis direction when pressing force was actually applied to the relationship that was obtained in advance.

Other aspects of Embodiment 2 are the same as those in Embodiment 1, and effects similar to those in Embodiment 1 are achieved.

Furthermore, with Embodiment 2, the time required for counting can be shortened since there is no need for the displacement point counting unit 5 to count the total number of displacement points in the displacement area as in Embodiment 1, and the time required for arithmetic calculation in the pressing force deriving unit 6 can be shortened since the amount of data to be processed is reduced.

### Embodiment 3

In Embodiment 2, the displacement point counting unit 5 counts the number of displacement points that constitute the greatest width in the X axis direction of the displacement area. In contrast, in Embodiment 3, the displacement point counting unit 5 counts the number of displacement points that constitute the greatest width in the Y axis direction of the displacement area. Specifically, the displacement point counting unit 5 counts the number of displacement points aligned in the Y axis direction at the X axis direction position where the width in the Y axis direction of the displacement area is the greatest.

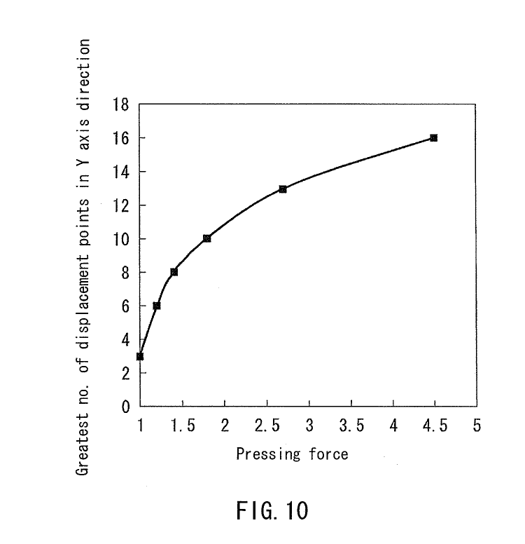

FIG. 10 is a diagram showing the relationship between the number of displacement points constituting the greatest width in the Y axis direction of the displacement area (the greatest number of displacement points in the Y axis direction) and the pressing force, which was obtained from FIGS. 6A to 6G. It can be understood from FIG. 10 that, for example, the greatest number of displacement points in the Y axis direction when the pressing force is 1.2 is 2 times that when the pressing force is 1, and the pressing force of 1 and the pressing force 1.2 can be distinguished from each other by counting the greatest number of displacement points in the Y axis direction. Furthermore, the greatest number of displacement points in the Y axis direction increases as the pressing force is increased to 1.4, 1.8, 2.7, and 4.5. It can be understood from the above that the intensity of pressing force can be detected by counting the greatest number of displacement points in the Y axis direction.

The pressing force intensity can be detected by obtaining the relationship between the pressing force and the greatest number of displacement points in the Y axis direction as shown in FIG. 10 in advance, and comparing the greatest number of displacement points in the Y axis direction when pressing force was actually applied to the relationship that was obtained in advance.

Other aspects of Embodiment 3 are the same as those in Embodiment 1, and effects similar to those in Embodiment 1 are achieved.

Furthermore, with Embodiment 3, the time required for counting can be shortened since there is no need for the displacement point counting unit 5 to count the total number of displacement points in the displacement area as in Embodiment 1, and the time required for arithmetic calculation in the pressing force deriving unit 6 can be shortened since the amount of data to be processed is reduced.

### Embodiment 4

In Embodiments 1 to 3, mainly the case of using a touch pen is described as the method of applying pressing force. Embodiment 4 describes the case of using a finger.

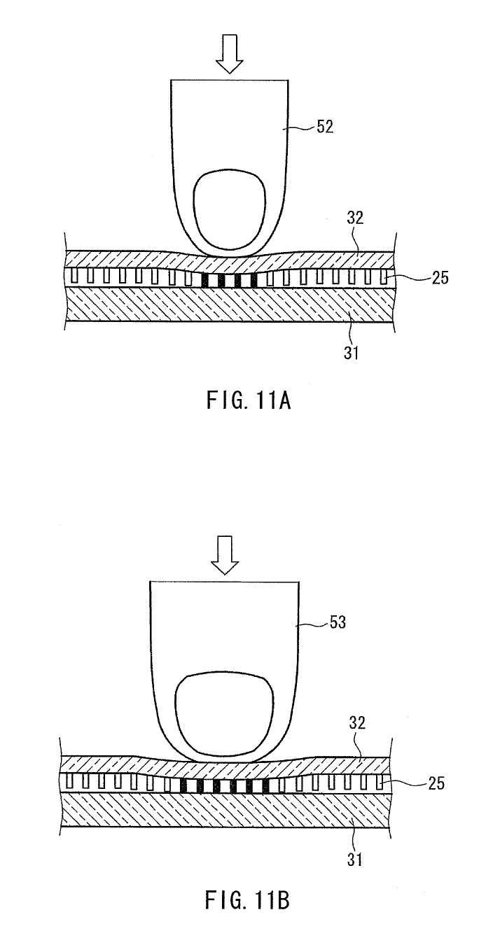

In the case of applying pressing force using a finger, it is difficult to uniquely determine the relationship between the number of displacement points and the pressing force since the finger size differs from person to person. FIGS. 11A and 11B are cross-sectional diagrams showing how displacement points (the size of a displacement area) change according to the size of a finger. Similarly to FIGS. 7A and 7B, among the projecting portions 25 formed on the counter substrate 32 in FIGS. 11A and 11B, the projecting portions 25 that configure the displacement detection units 30 for which the displacement point detection unit 3 determined that the counter substrate 32 was displaced are colored solid black. On the other hand, in FIGS. 11A and 11B, the projecting portions 25 that configure the displacement detection units 30 for which the displacement point detection unit 3 determined that the counter substrate 32 was not displaced are shown hollowed. As shown schematically in FIGS. 11A and 11B, it can be understood that even with the same pressing force, the contact bad 24 and the counter electrode 34 come into contact in more displacement detection units 30, and the number of displacement points is higher in the case of being pressed by a wide finger 53 shown in FIG. 11B than the case of being pressed with a narrow finger 52 shown in FIG. 11A (the number of displacement points is four in FIG. 11A and six in FIG. 11B).

If the sensitivity of pressing force detection is set based on the narrow finger 52, when the person with the wide finger 53 merely lightly presses the finger 53, the number of displacement points that is counted is approximately the same as that in the case where the person with the narrow finger 52 has strongly pressed the finger 52, and the pressing force is detected as being high. This results in the problem that it is difficult for a person with a wide finger to use a light pressing function.

Conversely, if the sensitivity of pressing force detection is set based on the wide finger 53, the person with the narrow finger 52 needs to press the finger 52 with more force than the person with the wide finger in order for the same number of displacement points to be counted, thus resulting in the problem of a feeling of tiredness.

As one method of resolving the above-described problem, there is a method of setting the pressing force detection reference in accordance with an average finger size. With this method, it is possible for a person with a finger size far away from the average finger size to feel a sense of user-unfriendliness.

The present embodiment proposes a different resolving method. Specifically, in the present embodiment, pressing force detection in the pressing force deriving unit 6 is performed not based on an absolute value of the number of displacement points as in Embodiments 1 to 3, but rather based on an amount of change in the number of displacement points during a pressing operation (i.e., a change in pressing force intensity).

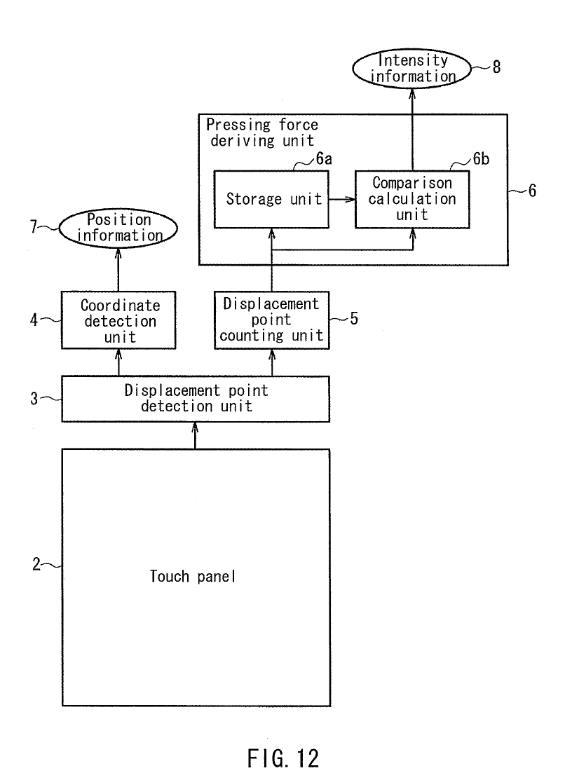

FIG. 12 is a block diagram of a touch sensor unit of a liquid crystal panel equipped with a touch sensor function according to Embodiment 4 of the present invention. In Embodiment 4, the pressing force deriving unit 6 differs from the pressing force deriving unit 6 in FIG. 1 in that a storage unit 6a and a comparison calculation unit 6b are included therein.

The following describes pressing force detection of the present embodiment using a specific example.

If a pressing operation performed using a finger is considered moment to moment, such an operation is generally considered to be performed such that first the touch surface is lightly touched by the finger, and then the touch surface is strongly pressed.

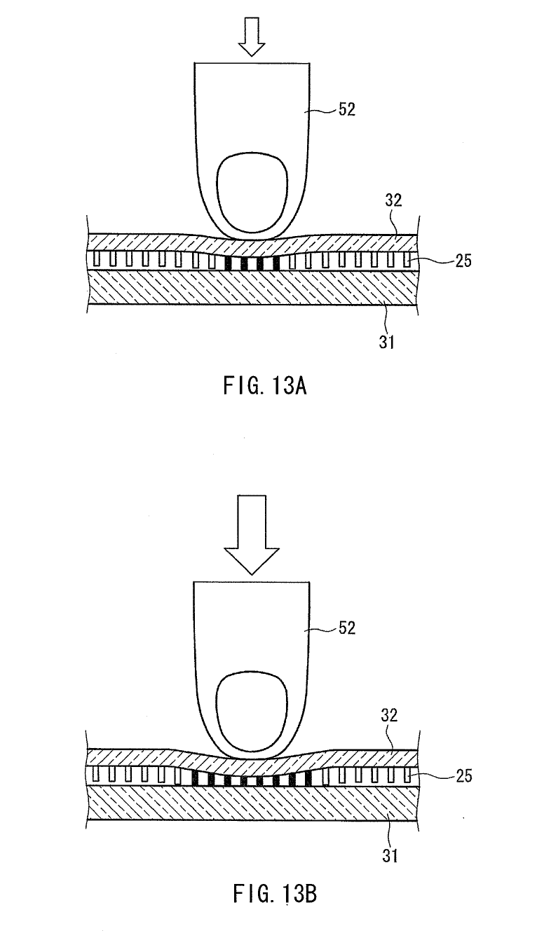

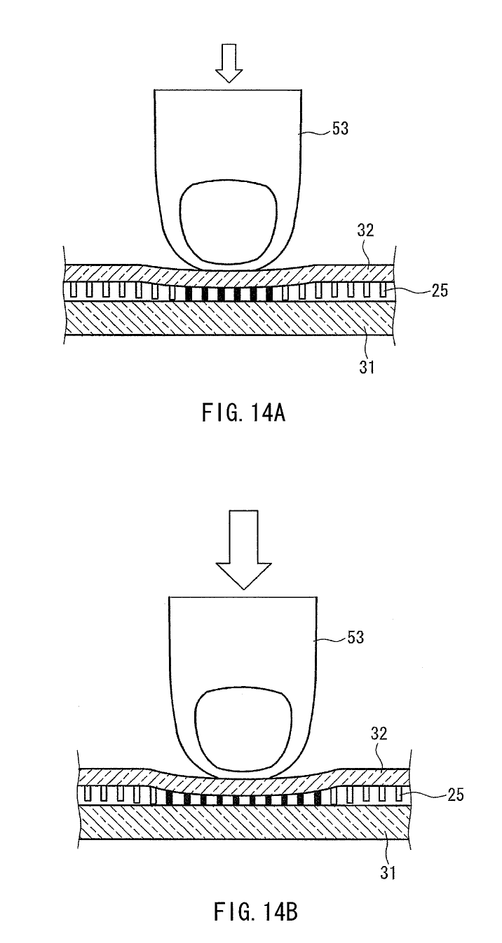

In view of this, the number of displacement points at the point in time when the touch surface was first lightly touched by the finger is counted by the displacement point counting unit 5 and stored in the storage unit 6a. Then data regarding the number of displacement points stored in the storage unit 6a and data regarding the number of displacement points counted by the displacement point counting unit 5 is sent to the comparison calculation unit 6b. The comparison calculation unit 6b performs a comparison calculation on the two data pieces. The comparison calculation unit 6b outputs intensity information 8 indicating light pressing since neither data piece is zero, and furthermore the difference between the data pieces is zero. For example, the number of displacement points when the touch surface is first lightly touched by the finger is four in the case of the narrow finger 52 shown in FIG. 13A and six in the case of the wide finger 53 shown in FIG. 14A. In this way, although the number of displacement points differs depending on the finger size, it is determined that the press is a weak press in both cases.

Thereafter, when the touch surface is pressed with a high force, the number of displacement points increases. The number of displacement points at this time is counted by the displacement point counting unit 5, and data regarding the number of displacement points is sent to the comparison calculation unit 6b. The comparison calculation unit 6b performs a comparison calculation on the data regarding the number of displacement points sent from the displacement point counting unit 5 and the data regarding the number of displacement points stored in the storage unit 6a. The comparison calculation unit 6b calculates an amount of change (amount of increase) in the number of displacement points sent from the displacement point counting unit 5 relative to the number of displacement points stored in the storage unit 6a, and outputs intensity information 8 in accordance with the amount of change. For example, in the case of the narrow finger 52, the number of displacement points when the finger is strongly pressed is eight as shown in FIG. 13B, and the amount of increase in the number of displacement points compared to FIG. 13A is four, and therefore it is determined that the pressing force in FIG. 13B is strong pressing. Also, in the case of the wide finger 52, the number of displacement points when the finger is strongly pressed is ten as shown in FIG. 14B, and the amount of increase in the number of displacement points compared to FIG. 14A is four, and therefore it is determined that the pressing force in FIG. 14B is strong pressing. In this way, although the number of displacement points differs depending on the finger size, it is determined that the press is a strong press in both cases since the amount of increase in the number of displacement points is the same.

Although setting is performed such that it is determined that a press is a strong press if the amount of increase in the number of displacement points is four or more in the above-described specific example, the value of the threshold and the number of threshold values for making a determination regarding the amount of increase in the number of displacement points is not limited to this. For example, the pressing force detection resolution can be set arbitrarily, such as determining that a press is a medium press if the amount of increase in the number of displacement points is greater than or equal to four and less than eight, and is a strong press if the amount of increase in the number of displacement points is greater than or equal eight.

Note that in FIGS. 13A, 13B, 14A, and 14B, similarly to FIGS. 11A and 11B, among the projecting portions 25 formed on the counter substrate 32, the projecting portions 25 that configure the displacement detection units 30 for which the displacement point detection unit 3 determined that the counter substrate 32 was displaced are colored solid black.

In the above description, the displacement point counting unit 5 counts the number of displacement points constituting the greatest width in the X axis direction or the Y axis direction of the displacement area as described in Embodiments 2 and 3, but the total number of displacement points constituting the displacement area may be counted. Note that compared with the latter case, in the former case the time required for counting in the displacement point counting unit 5 can be shortened, and the time required for arithmetic calculation in the pressing force deriving unit 6 can be shortened, and thus the former case is preferable.

As described above, with Embodiment 4, the intensity of pressing force can be detected regardless of the absolute value of the number of displacement points, thus enabling accurately detecting pressing force regardless of the finger size. Also, Embodiment 4 is not limited to the case of pressing with a finger, and can also be applied to the case of pressing with a touch pen.

Other aspects of Embodiment 4 are the same as those in Embodiment 1, and effects similar to those in Embodiment 1 are achieved.

The present invention enables different information to be input through differences in pressing force, and therefore can be used as a liquid crystal panel equipped with a touch sensor function.

1. A liquid crystal panel equipped with a touch sensor function comprising:
a touch panel that comprises a pair of substrates arranged opposing each other and a plurality of displacement detection units that are provided between the pair of substrates and output a signal due to one substrate out of the pair of substrates being pressed and becoming displaced;
a displacement point detection unit that, based on the signals output from the plurality of displacement detection units, binarily detects whether the one substrate has become displaced at each position of the plurality of displacement detection units;
a coordinate detection unit that detects coordinates of, among the plurality of displacement detection units, a displacement detection unit for which the displacement point detection unit detected that the one substrate became displaced, and outputs information regarding the position of the pressing;
a displacement point counting unit that counts the number of displacement detection units for which the displacement point detection unit detected that displacement occurred among the plurality of displacement detection units; and
a pressing force deriving unit that outputs information regarding a pressing force intensity based on the number of displacement detection units counted by the displacement point counting unit.

2. The liquid crystal panel equipped with a touch sensor function according to claim 1, wherein the plurality of displacement detection units each include a pair of electrodes respectively formed on mutually opposing faces of the pair of substrates and output the signal in a case where the pair of electrodes have come into contact with each other due to displacement of the one substrate.

3. The liquid crystal panel equipped with a touch sensor function according to claim 1, wherein the plurality of displacement detection units each include an electrostatic capacitance configured by a pair of electrodes respectively formed on mutually opposing faces of the pair of substrates and output the signal in accordance with a change in the electrostatic capacitance that occurs due to displacement of the one substrate.

4. The liquid crystal panel equipped with a touch sensor function according to claim 1, wherein the displacement point counting unit counts the total number of displacement detection units for which the displacement point detection unit detected that displacement occurred among the plurality of displacement detection units.

5. The liquid crystal panel equipped with a touch sensor function according to claim 1,
wherein the plurality of displacement detection units are arranged so as to be aligned in two orthogonal alignment directions, and
the displacement point counting unit counts the greatest number of displacement detection units aligned along one direction out of the two alignment directions among the displacement detection units for which the displacement point detection unit detected that displacement occurred.

6. The liquid crystal panel equipped with a touch sensor function according to claim 1, wherein the pressing force deriving unit compares the number of displacement detection units counted by the displacement point counting unit with a relationship between the number of displacement detection units and pressing force that has been set in advance, and outputs the information regarding the pressing force intensity in accordance with the number of displacement detection units.

7. The liquid crystal panel equipped with a touch sensor function according to claim 1,
wherein the pressing force deriving unit comprises:
a storage unit that stores the number of displacement detection units counted by the displacement point counting unit at the start of a pressing operation; and
a comparison calculation unit that performs a comparison calculation on the number of displacement detection units counted by the displacement point counting unit during a pressing operation and the number of displacement detection units stored in the storage unit.
